(19) United States
(12) Patent Application Publication
(10) Pub. No.: US 2015/0211410 A1
(43) Pub. Date: Jul. 30, 2015

(54) Engine Component Sleeve with an Integrated Heat Transfer Arrangement

(71) Applicant: Perkins Engines Company Limited, Peterborough, Cambridgeshire (GB)

(72) Inventors: Allan Saville, Peterborough (GB); Robert McDavid, Stamford (GB); Antonis Dris, Godmanchester (GB)

(73) Assignee: Perkins Engines Company Limited, Peterborough, Cambridgeshire (GB)

(21) Appl. No.: 14/418,032

(22) PCT Filed: May 24, 2013
(86) PCT No.: PCT/GB2013/051382

§ 371 Date: Jan. 28, 2015

(30) Foreign Application Priority Data
Aug. 1, 2012 (GB) 1213668.5

(51) Int. Cl. F01P 3/04; F02F 1/42; F02F 1/24; F02F 1/36

(52) U.S. Cl. CPC F01P 3/04; F02F 1/36; F02F 1/42; F02F 1/242

(57) ABSTRACT

This disclosure is directed towards an engine component sleeve with an integrated heat transfer arrangement. The sleeve includes a wall defining a passageway, and at least heat transfer arrangement. Each heat transfer arrangement includes at least one cavity enclosed within the wall and a working fluid located within the cavity.

### TECHNICAL FIELD

This disclosure is directed towards an engine component sleeve with an integrated heat transfer arrangement. The sleeve comprises a wall and a passageway, and the heat transfer arrangement is provided within the wall.

### BACKGROUND

An internal combustion engine typically comprises a plurality of cylinders in a cylinder block sealed by a cylinder head, with a piston located inside each cylinder. A combustion chamber is formed in between the piston head, the cylinder walls and the cylinder head face. Other engine components, such as valves, fuel injectors, thermocouples and spark plugs, may be mounted inside or on the cylinder head or cylinder block.

In order to reduce emissions and improve efficiency, the power densities of engines are being increased by reducing engine sizes and weights whilst maintaining the same power outputs. However, in order to maintain a similar output to larger engines, the relative pressures and temperatures within the combustion chamber are increased. The cylinder head face is known to reach very high temperatures during the engine operating cycle, particularly, during the combustion stroke, and has been measured at 360° C. The heat may be transferred from the combustion chamber via the cylinder walls and cylinder head face to a coolant system in the cylinder head or cylinder block. Heat may, therefore, be transferred to the engine components mounted inside or on the cylinder head or cylinder block. The high temperatures may damage and/or increase thermal mechanical fatigue of the engine components.

An example of an apparatus for reducing damage to engine components as a result of high engine temperatures is disclosed in US-B-3945353. This describes a fuel injection nozzle which has a hydraulically cooled heat pipe acting as a cooling system. The heat pipe transfers heat from the nozzle tip, which is exposed to the high temperatures of the combustion chamber, to circulating hydraulic fluid, which operates as a heat sink. The heat pipe operates by vapourising a cooling medium inside the heat pipe adjacent to the nozzle tip and by condensing the cooling medium adjacent to the circulating hydraulic fluid. However, such apparatus is only suitable for transferring heat away from the nozzle tip and adds significant complexity to the fuel injector.

Some engine components are commonly located in bores in the cylinder head. Sleeves, such as fuel injector sleeves or valve guide sleeves, may be located in the bores and the engine components located inside the sleeves. Furthermore, the bores may be located to position the sleeves and engine components adjacent to or partially within an engine coolant passage in the cylinder head. The sleeves enable the accurate positioning of the engine components within the cylinder head and may seal the engine components from the coolant fluid. However, the positioning of the sleeves may not enable a suitable transfer of heat for preventing damage to the engine components.

### SUMMARY

The disclosure provides a sleeve for locating an engine component in an engine, said sleeve comprising; a wall defining a passageway; and one or more heat transfer arrangements; each heat transfer arrangement comprising; at least one cavity enclosed within the wall; and a working fluid located within the cavity.

The disclosure further provides an engine comprising such a sleeve.

By way of example only, embodiments of an engine component sleeve with an integrated heat transfer arrangement are now described with reference to, and as shown in, the accompanying drawings.

### BRIEF DESCRIPTION OF THE DRAWINGS

FIG. 1 is a perspective view of an engine component sleeve of the present disclosure;

FIG. 2 is a cross-sectional side elevation of the engine component sleeve of FIG. 1; and

FIG. 3 is a cross-sectional side elevation of a cylinder head in which the engine component sleeve of FIGS. 1 and 2 is located.

### DETAILED DESCRIPTION

The present disclosure is generally directed towards a sleeve which is suitable for locating an engine component in an engine. The sleeve comprises a wall which defines a passageway. The engine component is seated in the passageway and a heat transfer arrangement is provided within the wall.

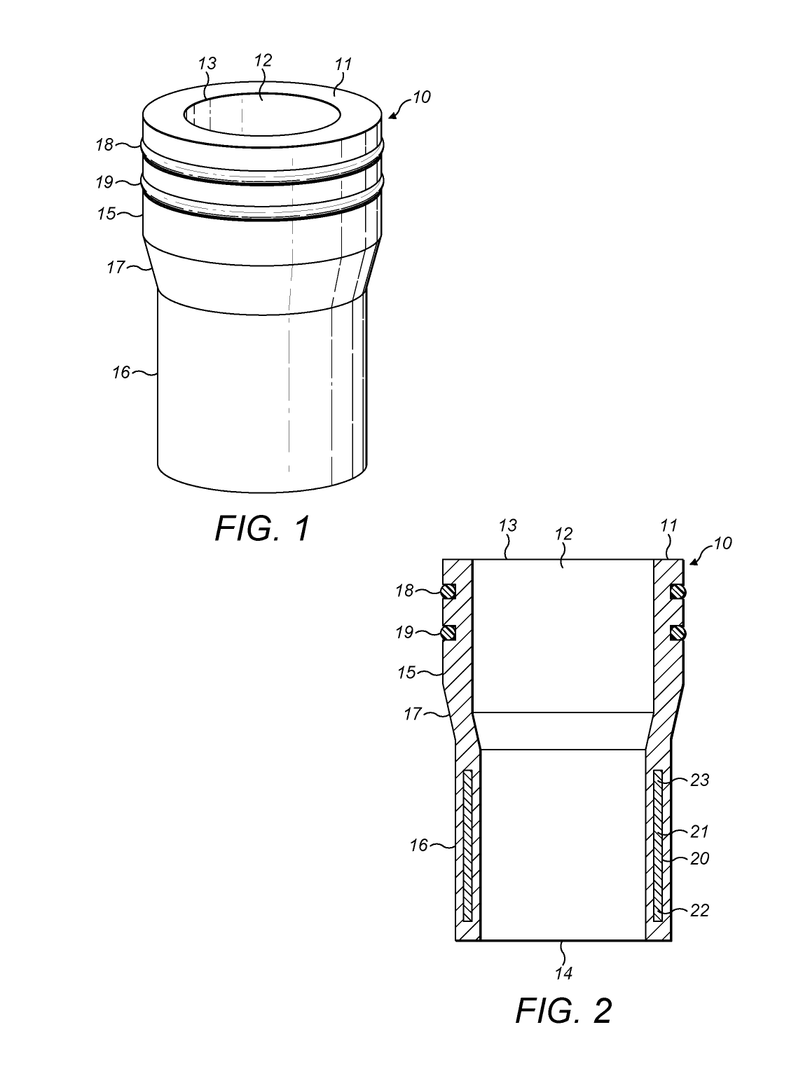

FIGS. 1 and 2 illustrate an embodiment of a sleeve 10 of the present disclosure. The sleeve 10 may be used for locating an engine component in an engine and, in particular, may be for locating an engine component in a cylinder head or a cylinder block. The engine component may be, for example, a fuel injector, valve stem, thermocouple or spark plug. In particular, the sleeve 10 may be a fuel injector sleeve for locating a fuel injector in a cylinder head adjacent to an engine coolant passage and such that the fuel injector tip protrudes into a combustion chamber of the engine. Alternatively, the sleeve 10 may be a valve guide for locating a valve stem to position the valve head adjacent to a combustion chamber and to an air intake/exhaust passage.

The sleeve 10 may be substantially tubular (i.e. being formed from a substantially hollow cylinder) and comprises a wall 11 defining an internal passageway 12. The passageway 12 may extend from a first opening 13 at one end of the sleeve 10 to a second opening 14 at the other end of the sleeve 10. An engine component may be inserted into and located in the passageway 12. The cross-sectional shape of the sleeve 10, may be substantially circular, oval, square, rectangular, polygonal or any other suitable shape and may vary along the length of the sleeve 10. One or more grooves may extend at least partially along the length or around the perimeter of the wall 11. The wall may be formed of any suitable material, such as stainless steel, aluminium, titanium and/or nickel.

The thickness of the wall 11 may be substantially the same, or may vary, along the length of the sleeve 10. The external diameter of the sleeve 10 may be substantially the same, or may vary, along its length. The wall 11 may comprise a first section 15 connected to a second section 16 by a frusto-conical section 17. The external diameter of the first section 15 may be larger than the external diameter of the second section 16. The internal diameter of the first section 15 may be larger than the internal diameter of the second section 16. The frusto-conical section 17 may provide a continuity in the inner and outer surfaces of the wall 11 by providing a smooth reduction from the internal and external diameters of the first section 15 to the respective internal and external diameters of the second section 16.

The sleeve 10 may comprise one or more compression seals 18, 19 for forming a seal between the outer side of the wall 11 and an inner wall of a bore in which the sleeve 10 is located (further described below). The compression seals 18, 19 may be located at any appropriate position along the length of the sleeve and may be located on the outer surface of the wall 11 or in the above mentioned grooves in the wall surface. The wall 11 may have a circular cross-section, as previously described herein, and the compression seals 18, 19 may encircle the entire outer perimeter of the wall 11.

One or more heat transfer arrangements 20 are provided within, or enclosed within, the thickness of the wall 11, and may be located at any suitable position to transfer heat from a high temperature source, being a heat source, to a lower temperature source, being a heat sink. The heat sink and heat source may be located adjacent to the sleeve 10 and may be any part of the engine, for example the combustion chamber, an engine coolant system, the sleeve 10 itself or the engine component located in the sleeve 10. Each heat transfer arrangement 20 may be passive such that, in order to transfer heat, the heat transfer arrangement 20 requires no external work input (i.e. no further energy is required beyond the energy provided from the heat source).

Each heat transfer arrangement 20 may comprise a cavity 21 enclosed within the wall 11 of the sleeve 10 which may extend substantially along the length of the sleeve 11. Each cavity 21 may be sealed within the wall 11. Each cavity 21 may comprise a higher temperature region 22 and a lower temperature region 23, wherein the higher temperature region 22 has a higher temperature than the lower temperature region 23. In FIG. 2 the high temperature and lower temperature regions 22, 23 are shown at either end of the cavity 20, although it is anticipated that they may be in other orientations.

A working fluid is provided inside the cavity 20 to transfer heat from the higher temperature region 22 to the lower temperature region 23. The working fluid may continuously recirculate between the higher temperature region 22 and lower temperature region 23, and undergo no, one or a plurality of phase changes during each circulation. The working fluid may substantially evaporate at the higher temperature region 22 and substantially condense at the lower temperature region 23, thereby undergoing two phase changes.

The working fluid may be of any type suitable for the formation and temperature operating range of the heat transfer arrangements 20, for example isobutene, ammonia, methanol, water, mercury, iodine, magnesium, toluene, sodium, lithium, potassium and the like. The material forming the sleeve 10 and the type of working fluid may be selected to be compatible with one another, or, alternatively, part of the wall 11 and/or a coating on the inner side of the cavity 21 may be formed from a material which is compatible with the working fluid.

The working fluid may be transferred from the higher temperature region 22 to the lower temperature region 23 by bulk convection due to pressure differences and/or by diffusion due to concentration gradient differences between the ends 22, 23. The working fluid may be transferred from the lower temperature region 23 to the higher temperature region 22 due to gravitational forces. A heat transfer arrangement 20 utilising such a process is commonly known as a thermosiphon. The thermosiphon may be open or closed loop and may be single, two or more phase. In an example, the working fluid vaporises at the higher temperature region 22, flows to the lower temperature region 23 substantially due to bulk convection and/or diffusion, condenses at the lower temperature region 23 and returns to the higher temperature region 22 due to gravity (for example by trickling down the walls of the cavity 21).

Alternatively, the working fluid may be transferred from the lower temperature region 23 to the higher temperature region 22 by capillary action (i.e. surface tension effects) in a wick. A heat transfer arrangement 20 incorporating such an apparatus is commonly known as a heat pipe. The wick may be of any suitable composition, such as porous ceramic, sintered metal or wire mesh, and may be in any suitable arrangement known in the art, such as corrugated, annular, screen, grooved or open channelled, meshed or be formed as an artery within the cavity 21. The composition of the wick, working fluid and walls of the cavity 21 may be selected to be compatible with one another.

In one example, working fluid vaporises at the higher temperature region 22, flows to the lower temperature region 23 substantially due to bulk convection and/or diffusion, condenses at the lower temperature region 23 and returns to the higher temperature region 22 due to capillary action through the wick. A heat pipe may be a suitable form of heat transfer arrangement 20 where the sleeve 10 for an engine component is oriented such that gravity cannot act to transfer the working fluid from the higher temperature region 22 to the lower temperature region 23. An example of such an orientation is when the higher temperature region 22 is located higher than the lower temperature region 23.

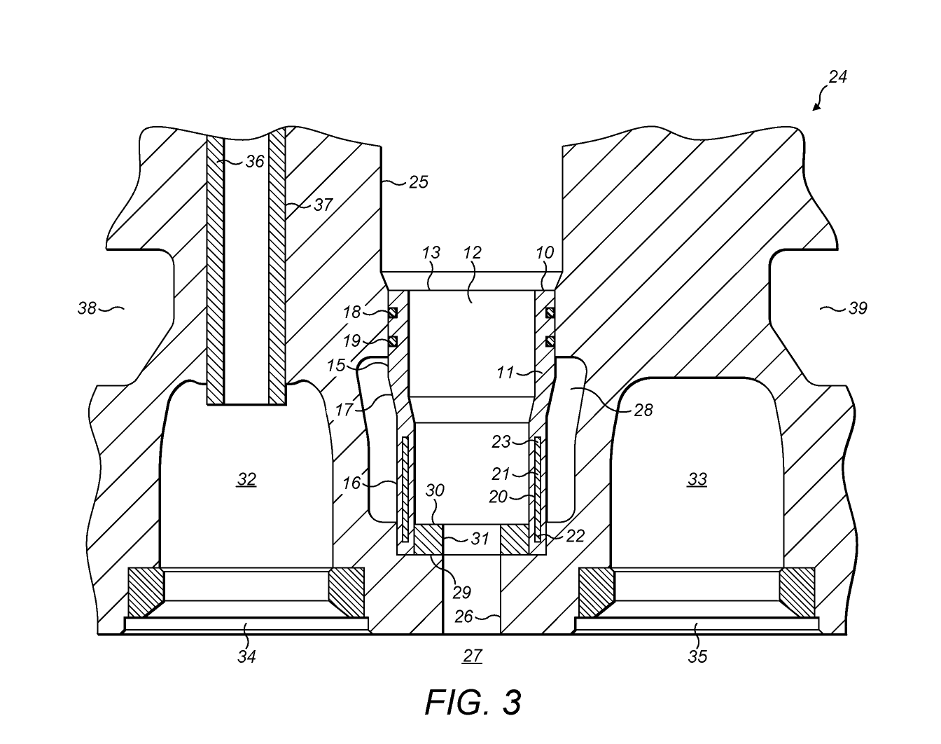

FIG. 3 illustrates an exemplary arrangement of a sleeve 10 located in a cylinder head 24. The sleeve 10 may be located in a first bore 25 and may be used to locate a fuel injector (not shown) such that the tip of the fuel injector protrudes through a second bore 26 and into a combustion chamber 27. The sleeve 10 may be at least partially enclosed within an engine coolant passage 28 and a coolant fluid in the engine coolant passage 28 may contact at least a part of the outer side of the wall 11. The second bore 26 may have a width less than that of the first bore 25, defining a shoulder 29 therebetween with which the sleeve 10 engages.

The sleeve 10 may be secured in the first bore 25 by any means, for example using an interference fit or an adhesive using compression seals 18, 19. A sealing member 30 may be located on the inner side of the wall 11 and may engage with, or be in contact with, the shoulder 29. The sealing member 30 may extend at least partway along the length of the sleeve 10 such that the fuel injector is seated upon the sealing member 30. The fuel injector is located through a central bore 31 in the sealing member 30. The sealing member 30 may form a seal between the shoulder 30, the sleeve 10 and the first bore 25. The sealing member 30 may be formed from copper. Alternatively, the sealing member 30 and the sleeve 10 may be formed as a single part.

During a combustion cycle high temperatures may be generated in the combustion chamber 27, thereby forming a heat source. The heat is transferred from the cylinder head face, through the fuel injector and/or cylinder head 24 and to the sleeve 10. The one or more heat transfer arrangements 20 transfer heat through the wall 11 of the sleeve 10 to the coolant fluid, which acts as a heat sink. The heat transfer arrangements 20 may be located such that the cavity 21 extends from adjacent the end of the sleeve 10 closest to the combustion chamber 27, through the wall 11 along the length of the sleeve 10 and to adjacent the engine coolant passage 28.

The cylinder head 24 may further comprise one or more air intake/exhaust passages 32, 33 which communicate air with the combustion chamber 27. Valve ports 34, 35, located between the combustion chamber 27 and the air passages 32, 33, may be opened or closed by valves (not shown) seated in a valve guide sleeve 36. The valve guide sleeve 36 may be seated in a bore 37 which may be located adjacent to engine coolant passages 38, 39. One or more heat transfer arrangements 20 are provided in the wall of the valve guide sleeve 36, as described previously herein (but not shown in the figures), to improve heat transfer from the air passages 32, 33 and/or cylinder head to coolant fluid in the engine coolant passages 38, 39.

### INDUSTRIAL APPLICABILITY

The heat transfer arrangements 20 increase the rate of heat transfer along the wall 11 relative to the rate which would occur if the wall 11 did not have heat transfer arrangements 20 (i.e. the wall comprised solid material). This improvement may be a result of replacing conductive heat transfer with both convective heat transfer and mass transfer (e.g. diffusion).

The seals formed between the sleeve 10 and the engine may prevent coolant fluid contacting the engine component located therein, thereby protecting the engine component from any potential corrosive effect of the coolant fluid. By improving heat transfer to the engine coolant, the mechanical fatigue of the engine component due to exposure to high temperatures may be reduced. Furthermore, higher temperatures can be achieved within the combustion chamber, thus improving power density, without increasing the degradation of the engine component.

The sleeve 10 may be retrofitted to engines in place of engine component sleeves which do not comprise heat transfer arrangements 20. Furthermore, the sleeve 10 may be removed, repaired and/or replaced during maintenance of the engine. Such a feature may be particularly beneficial where the heat transfer arrangement 20 is a heat pipe, as the wick may need replacing periodically.

1. A sleeve for locating an engine component in an engine, said sleeve comprising:
a wall defining a passageway; and
at least one heat transfer arrangement; each heat transfer arrangement comprising:
at least one cavity enclosed within the wall; and
a working fluid located within the cavity.

2. A sleeve as claimed in claim 1 wherein each heat transfer arrangement is a passive heat transfer arrangement.

3. A sleeve as claimed in claim 1 wherein the at least one cavity comprises a higher temperature region and a lower temperature region.

4. A sleeve as claimed in claim 3 wherein the working fluid is selected to evaporate in the higher temperature region and condense in the lower temperature region.

5. A sleeve as claimed in claim 3 wherein the working fluid transfers heat from the higher temperature region to the lower temperature region.

6. A sleeve as claimed in claim 1 wherein each heat transfer arrangement comprises a plurality of cavities.

7. A sleeve as claimed in claim 1 wherein the wall comprises a first section connected to a second section by a frusto-conical section, the first section have a larger external diameter than the second section.

8. A sleeve as claimed in claim 1 wherein each heat transfer arrangement is a thermosiphon or a heat pipe.

9. An engine comprising a sleeve of claim 1.

10. An engine as claimed in claim 9 wherein the engine component is located in said sleeve, said engine component being selected from a fuel injector, a valve, a spark plug and a thermocouple.

11. An engine as claimed in claim 9, wherein the at least one cavity includes a higher temperature region and a lower temperature re ion and is positioned in the wall to locate the higher temperature region of the at least one cavity adjacent to a heat source and the lower temperature region of the at least one cavity adjacent to a heat sink.

12. An engine as claimed in claim 11 wherein the heat source is a combustion chamber.

13. An engine as claimed in claim 11 wherein the heat sink is a coolant fluid, the coolant fluid being located in a coolant passage.

14. An engine as claimed in claim 13 wherein the outer side of the wall is at least partially exposed to the coolant fluid, and the sleeve is sealed to the engine to prevent coolant fluid contacting the engine component.

15. An engine as claimed in claim 9 comprising a cylinder head, the sleeve being located in the cylinder head.

16. A sleeve as claimed in claim 2 wherein the at least one cavity comprises a higher temperature region and a lower temperature region.

17. A sleeve as claimed in claim 16 wherein the working fluid is selected to evaporate in the higher temperature region and condense in the lower temperature region.

18. A sleeve as claimed in claim 4 wherein the working fluid transfers heat from the higher temperature region to the lower temperature region.

19. A sleeve as claimed in claim 5 wherein each heat transfer arrangement comprises a plurality of cavities.

20. A sleeve as claimed in claim 19 wherein the wall comprises a first section connected to a second section by a frusto-conical section, the first section have a larger external diameter than the second section.
